(19) United States
(12) Patent Application Publication
(10) Pub. No.: US 2012/0050649 A1
(43) Pub. Date: Mar. 1, 2012

(54) DISPLAY DEVICE

(75) Inventor: In Jae YEO, Seoul (KR)

(73) Assignee: LG INNOTEK CO., LTD., Seoul (KR)

(21) Appl. No.: 13/198,386

(22) Filed: Aug. 4, 2011

(30) Foreign Application Priority Data
Aug. 26, 2010 (KR) 10-2010-0083016

(51) Int. Cl. G02F 1/13357

(52) U.S. Cl. 349/65

(57) ABSTRACT

Provided is a display device. The display device includes a light guide plate and a light source disposed on a lateral surface of the light guide plate. An optical path conversion part corresponding to the light source is disposed in the light guide plate.

### CROSS-REFERENCE TO RELATED APPLICATION

This application claims the benefit under 35 U.S.C. §119 of Korean Patent Application No. 10-2010-0083016, filed on Aug. 26, 2010, which is hereby incorporated by reference in its entirety.

### BACKGROUND

Embodiments relate to a display device.

As our information society develops, needs for diverse forms of display devices are increasing. Among these, an LCD is being widely used as a movable flat panel display device (PDP) because the LCD has advantages of good image quality, lightness, a thin profile, and low power consumption.

However, since the LCD is a non-illuminant display device that cannot emit light by itself, a separate external light source is required for realizing a high-quality image. Thus, the LCD may further include a backlight unit as a light source for a liquid crystal display panel except the liquid crystal display panel.

Such a backlight unit may be classified into an edge-lighting type backlight unit and a direct-lighting type backlight unit according to a light emitting direction of the light source. The edge-lighting type backlight unit has a relatively thin thickness. Thus, the edge-lighting type backlight unit is mainly used for LCDs, which are used in a thin apparatus such as portable communication apparatuses.

Recently, as the LED used as the light source of the backlight unit is continuously increased in output voltage, a distance between the LEDs become continuously wider. However, an LED of FIG. 1 has a relatively small amount of light emitted to a lateral surface when compared to an amount of light emitted to an optical axis direction. Thus, there is a limitation that the LED may have low color uniformity and brightness uniformity.

To solve the limitation, it may be considered to expand a light mixing region for mixing light from adjoining LEDs. However, in this case, a space occupied by the module in the LCD display device may be increased to significantly increase a size of a final product when compared to that of a portion for displaying an image. Thus, the product may be degraded in product competitiveness.

### BRIEF SUMMARY

Embodiments provide a display device having improved color uniformity and brightness uniformity.

In one embodiment, a display device includes: a light guide plate; and a light source disposed on a lateral surface of the light guide plate, wherein an optical path conversion part corresponding to the light source is disposed in the light guide plate.

In another embodiment, a display device includes: a light guide plate; and a light source disposed on a lateral surface of the light guide plate, wherein a groove corresponding to the light source is defined in the light guide plate.

In further another embodiment, a display device includes: a display panel; a light guide plate disposed under the display panel; and a plurality of light sources emitting light onto the light guide plate, wherein grooves respectively corresponding to the light sources are defined in the light guide plate.

The details of one or more embodiments are set forth in the accompanying drawings and the description below. Other features will be apparent from the description and drawings, and from the claims.

### BRIEF DESCRIPTION OF THE DRAWINGS

FIG. 1 is an exploded perspective view of a liquid crystal display device according to an embodiment.

FIG. 2 is a perspective view of a light source, a wavelength conversion part, and a light guide plate according to an embodiment.

FIG. 3 is a sectional view illustrating one surface of a backlight assembly according to an embodiment.

FIGS. 4 to 11 are views illustrating various examples of an optical path conversion part according to an embodiment.

FIG. 12 is a view illustrating uniformity of light emitted from the light source according to an embodiment.

FIG. 13 is a view illustrating values obtained by measuring chromaticity coordinates of light emitted from a backlight unit according to an embodiment.

FIG. 14 is a view illustrating values obtained by measuring brightness of light emitted from the backlight unit according to an embodiment.

### DETAILED DESCRIPTION

In the descriptions of embodiments, it will be understood that when a substrate, a frame, a sheet, a layer, or a pattern is referred to as being ‘on’ a substrate, a substrate, a frame, a sheet, a layer, or a pattern, it can be directly on another layer or substrate, or intervening layers may also be present. Further, it will be understood that when a layer is referred to as being ‘under’ another layer, it can be directly under another layer, and one or more intervening layers may also be present. Further, the reference about ‘on’ and ‘under’ each component will be made on the basis of drawings. In the drawings, the thickness or size of each layer is exaggerated, omitted, or schematically illustrated for convenience in description and clarity. Also, the size of each element does not entirely reflect an actual size.

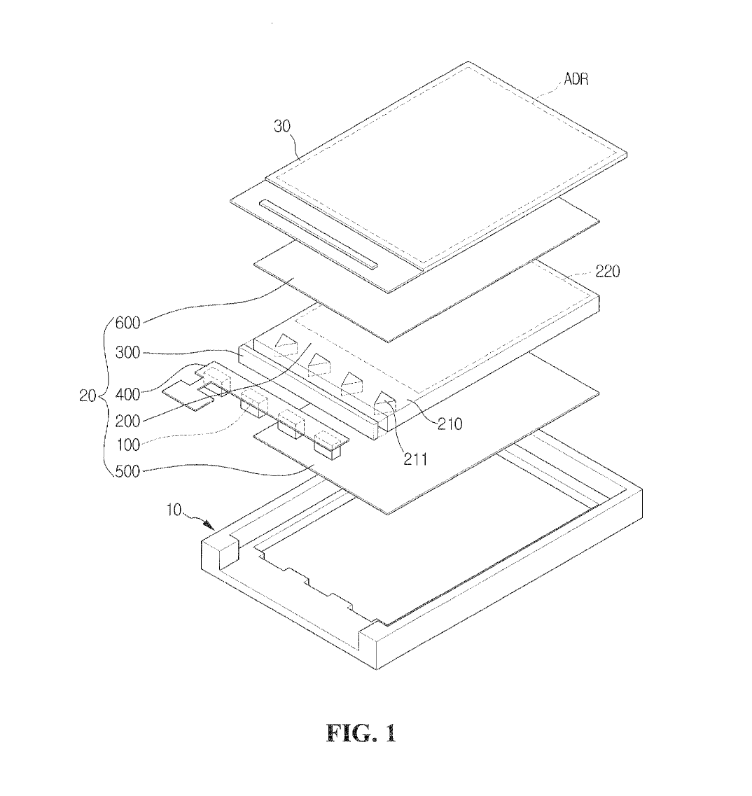

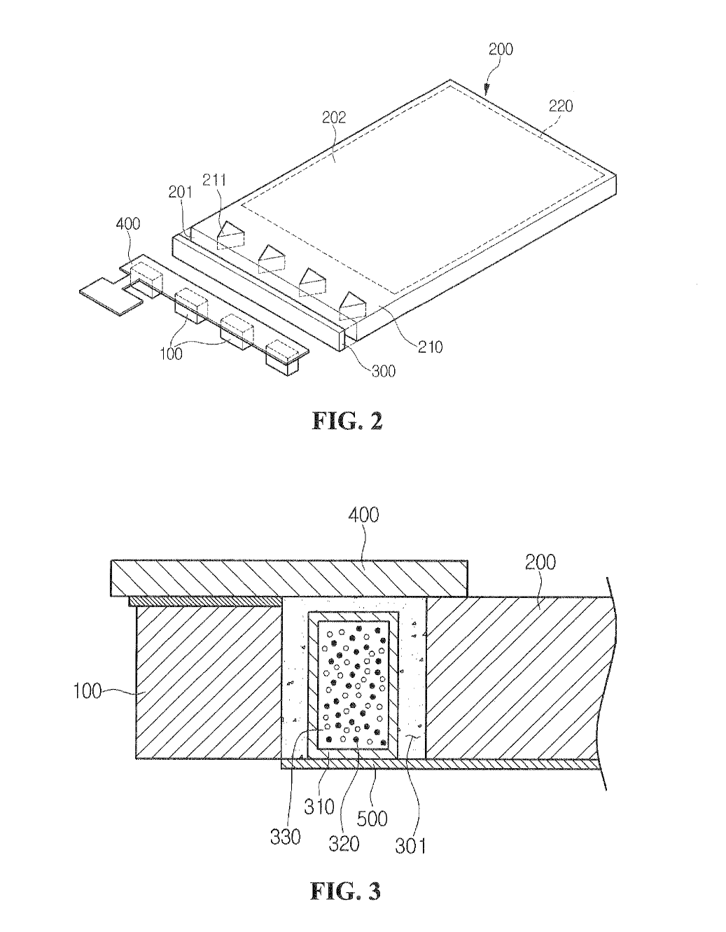

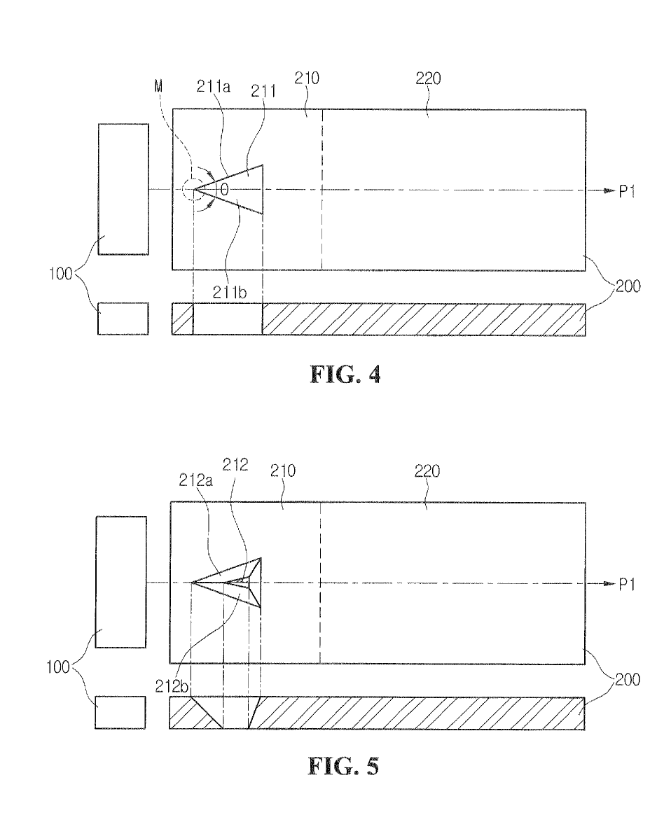

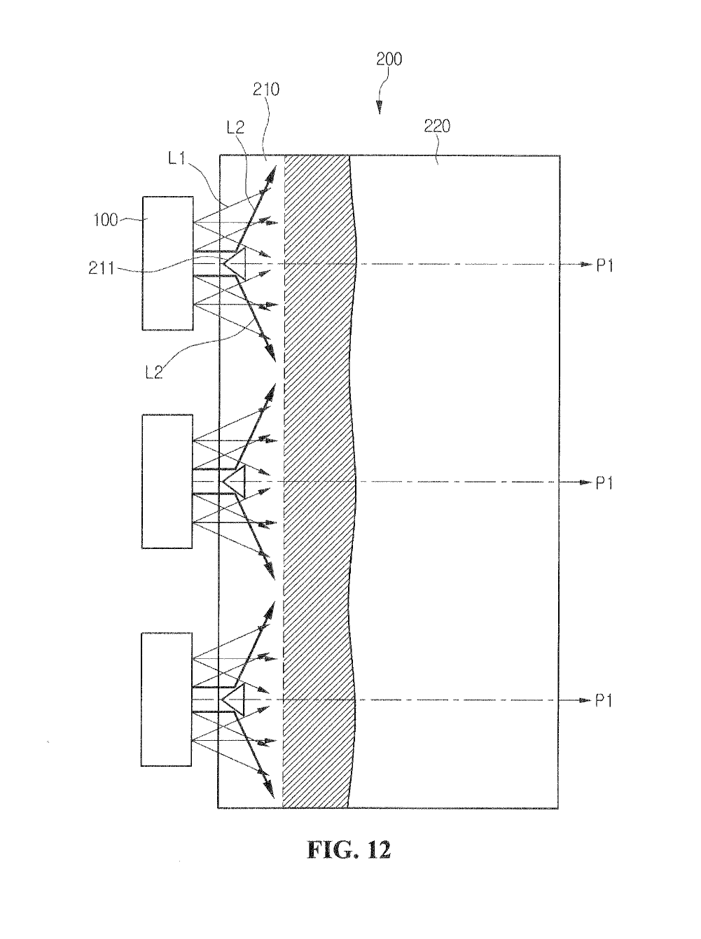

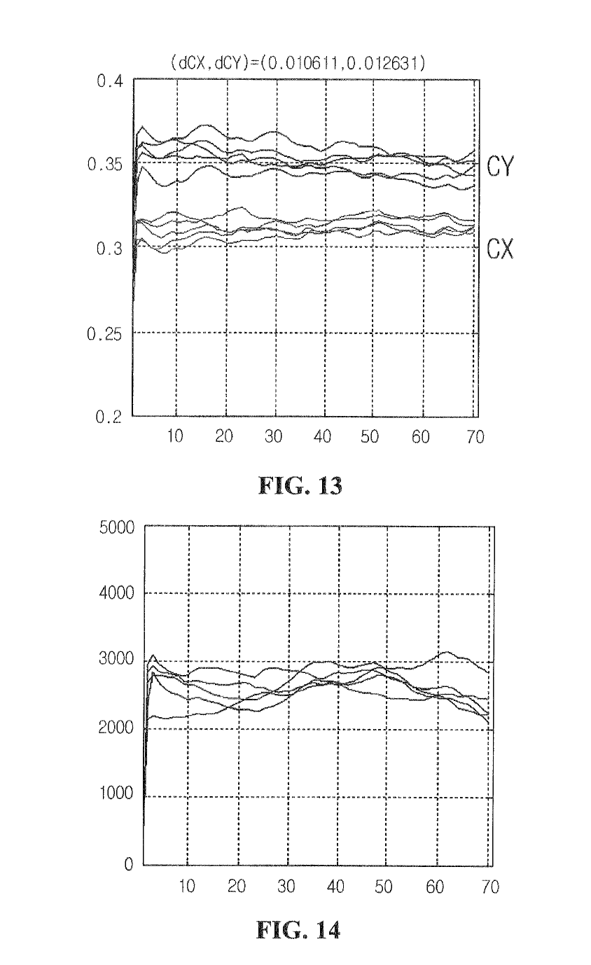

FIG. 1 is an exploded perspective view of a liquid crystal display device according to an embodiment. FIG. 2 is a perspective view of a light source, a wavelength conversion part, and a light guide plate according to an embodiment. FIG. 3 is a sectional view illustrating one surface of a backlight assembly according to an embodiment. FIGS. 4 to 11 are views illustrating various examples of an optical path conversion part according to an embodiment. FIG. 12 is a view illustrating uniformity of light emitted from the light source according to an embodiment. FIG. 13 is a view illustrating values obtained by measuring chromaticity coordinates of light emitted from a backlight unit according to an embodiment. FIG. 14 is a view illustrating values obtained by measuring brightness of light emitted from the backlight unit according to an embodiment.

Referring to FIGS. 1 to 14, a liquidcrystal display device includes a mold frame 10, a backlight assembly 20, and a liquid crystal panel 30.

The mold frame 10 receives the backlight assembly 20 and the liquid crystal panel 30. The mold frame 10 has a square frame shape. For example, the mold frame 10 may be formed of plastic or reinforcement plastic.

Also, a chassis surrounding the mold frame 10 and supporting the backlight assembly 20 may be disposed under the mold frame 10. The chassis may be disposed on a side surface of the mold frame 10.

The backlight assembly 20 is disposed inside the mold frame 10 to generate light, thereby emitting the generated light toward the liquid crystal panel 30. That is, the mold frame 10 and the backlight assembly 20 arc coupled to each other to constitute a backlight unit emitting light onto the liquid crystal panel 30.

The backlight assembly 20 includes a reflective sheet 500, a light guide plate 200, optical path conversion parts 21, a plurality of light sources, e.g., a plurality of light emitting diodes (LEDs) 100, a wavelength conversion part 300, a plurality of optical sheets 500, and a flexible printed circuit board (FPCB).

The reflective sheet 500 reflects light emitted from the LEDs 100 upward.

The light guide plate 200 is disposed on the reflective sheet 500. The light guide plate 200 receives the light emitted from the LEDs 100 to reflect the incident light upward through reflection, refraction, and dispersion.

The light guide plate 200 is an optical member for converting point light incident from the LEDs 100 into plane light. The light guide plate 200 may be formed of polycarbonate (PC) or polymethylmethaacrylate (PMMA).

The light guide plate 200 has a light incident surface facing the LEDs 100. That is, a surface facing the LEDs 100 of side surfaces of the light guide plate 200 is a light incident surface.

Also, the light guide plate 200 has a central region 220 corresponding to an active display region (ADR) of the liquid crystal panel 30 and a peripheral region 210 around the central region 220. The active display region ADR is a region in which an image is displayed on the liquid crystal panel 30. The central region 220 may accord with the active display region ADR. The peripheral region 210 is disposed between the central region 220 and the LEDs 100.

A region between the central region 220 and the LEDs 100 in the peripheral region 210 may be a light mixing part in which light emitted from the LEDs is mixed. Also, the central region 220 may be a region in which the mixed light is emitted upward as plane light.

A light blocking member for preventing light from being emitted upward may be disposed on the light mixing part. Also, the FPCB may be disposed on the light mixing part to serve as the light blocking member.

Referring to FIG. 2, the plurality of optical path conversion parts 211 may be disposed on the light guide plate 200. In detail, the optical path conversion parts 211 may be total reflection grooves 211 defined in the light guide plate 200. In more detail, the optical path conversion parts 211 may be total reflection grooves 211 defined in a top surface of the light guide plate 200. The total reflection grooves 211 may pass through a portion of the light guide plate 200 or the entire light guide plate 200.

Each of the optical path conversion parts 211 is disposed in a region corresponding to each LED 100. In more detail, each of the optical path conversion parts 211 may be disposed corresponding to each LED 100. In more detail, the optical path conversion parts 211 may be disposed corresponding to optical axes P1 of the LEDs 100, respectively.

Each of the optical path conversion parts 211 may have a first reflection surface 211a inclined with respect to each of the optical axes P1 of the LEDs 100. The optical axis P1 of the LED 100 may be perpendicular to the light incident surface 201 of the light guide plate 200.

Also, the first reflection surface 211a is inclined with respect to the light incident surface 201 of the light guide plate 200. The first reflection surface 211a may be inclined or perpendicular with respect to the top surface of the light guide plate 200.

Also, each of the optical path conversion parts 211 has a second reflection surface 211b. The second reflection surface 211b is inclined with respect to the optical axis P1 of the LED 100. Also, the second reflection surface 211b is inclined with respect to the light incident surface 201 of the light guide plate 200. The second reflection surface 211b may be inclined or perpendicular with respect to the top surface of the light guide plate 200.

The first reflection surface 211a and the second reflection surface 211b may be inner surfaces of the total reflection grooves 211. Thus, each of the total reflection grooves 211 may have a triangular shape when viewed from a top side.

Also, the first reflection surface 211a and the second reflection surface 211b meet each other. That is, the first reflection surface 211a and the second reflection surface 211b cross each other. Here, a portion at which the first and second reflection surfaces 211a and 211b meet each other may be corresponding to the optical axis Pl of the LED 100.

Also, the first reflection surface 211a and the second reflection surface 211b may be symmetric with respect to each other. That is, the total reflection grooves 211 may have a symmetric structure with respect to the optical axes of the LEDs, respectively.

An angle θ between the first reflection surface 211a and the second reflection surface 211b may be less than about 180°. In detail, the angel θ between the first reflection surface 211a and the second reflection surface 211b may range from about 15° to about 60°. In detail, the angel θ between the first reflection surface 211a and the second reflection surface 211b may range from about 30° to about 40°.

When the angle θ between the first reflection surface 211a and the second reflection surface 211b is less than about 15°, a path of light emitted from the LEDs 100 may not be changed nearly. On the other hand, when the angle θ between the first reflection surface 211a and the second reflection surface 211b is greater than about 60°, the first and second reflection surfaces 211a and 221b may not reflect light emitted from the LEDs 100.

The first reflection surface 211a and the second reflection surface 211b may totally reflect light emitted from the LEDs 100 due to a refractive index difference between the light guide plate 200 and air within the total reflection grooves 211. That is, the first reflection surface 211a and the second reflection surface 211b may be total reflection surfaces.

Also, as shown in FIG. 5, the total reflection groove 212 may have a truncated pyramid shape. Specifically, the total reflection groove 212 may have a width gradually decreasing downward from the top surface of the light guide plate 200. Thus, the inner surfaces 211a and 211b of the total reflection groove 211 may be inclined with respect to the top surface of the light guide plate 200.

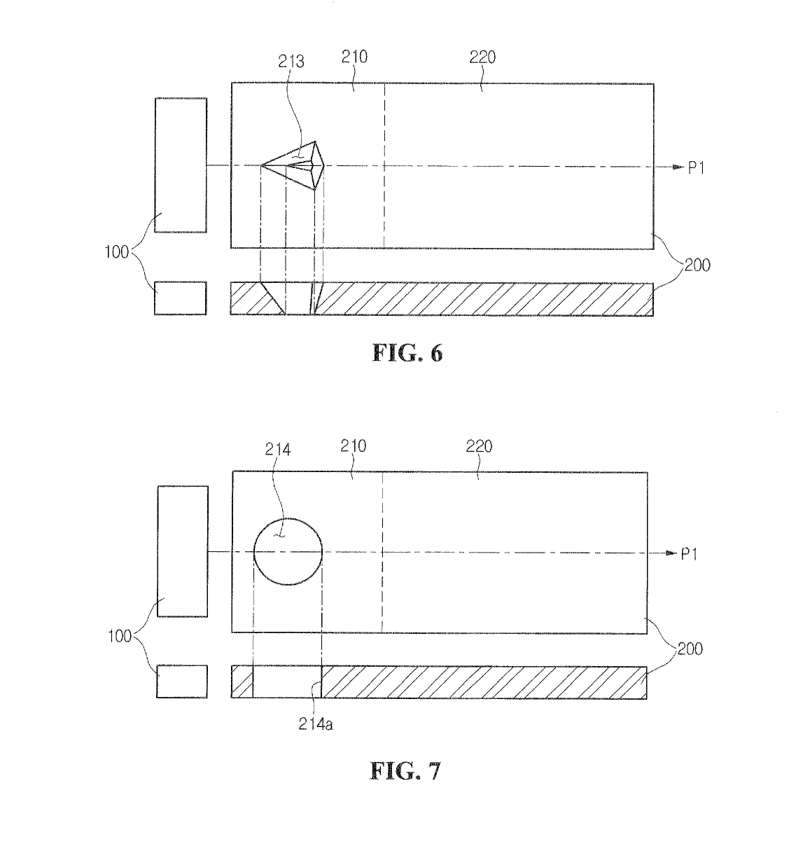

Also, as shown in FIG. 6, a total reflection groove 213 may have a quadrangular pyramid frustum shape. Similarly, the total reflection groove 213 may have a width gradually decreasing downward from the top surface of the light guide plate 200.

Also, as shown in FIG. 7, a total reflection groove 214 may have a cylindrical shape. Thus, the total reflection groove 214 may have a curved inner surface 214a.

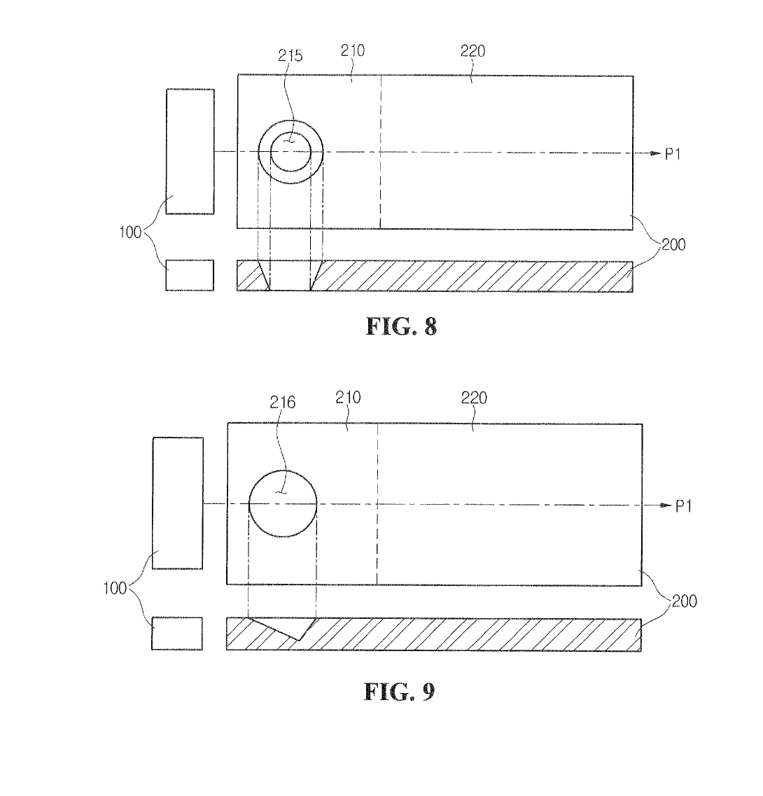

Also, as shown in FIG. 8, a total reflection groove 215 may have a truncated circular cone shape. Similarly, the total reflection groove 215 may have a width gradually decreasing downward from the top surface of the light guide plate 200.

Also, as shown in FIG. 9, a total reflection groove 216 may have a cone shape. Here, the total reflection groove 216 may not pass through the light guide plate 200.

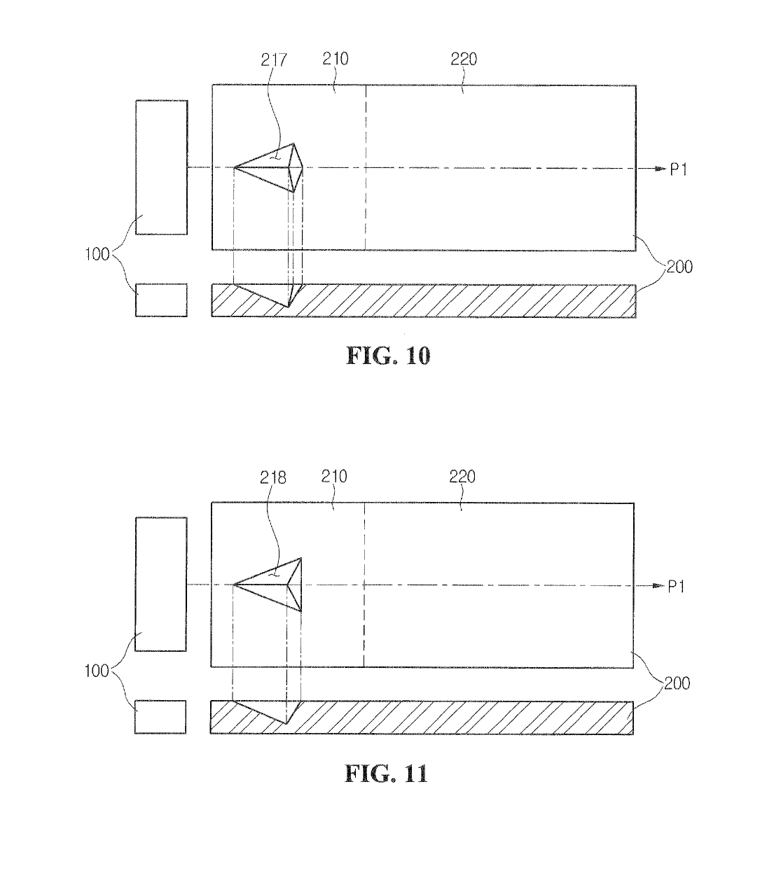

Also, as shown in FIG. 10, a total reflection groove 217 may have a quadrangular pyramid shape. Here, the total reflection groove 217 may not pass through the light guide plate 200.

Also, as shown in FIG. 11, a total reflection groove 218 may have a triangular pyramid shape. Here, the total reflection groove 218 may not pass through the light guide plate 200.

When the total reflection grooves 216, 217, and 218 do not pass through the light guide plate 200, a ratio of a thickness of the light guide plate 200 to each of depths of the total reflection grooves 216, 217, and 218 may be about 1:0.6 to about 1:0.99.

As described above, the total reflection grooves 211, 212, 213, 214, 215, 216, 217, and 218 may be defined in the top surface of the light guide plate 200. Here, each of the total reflection grooves 212, 213, 214, 215, 216, 217, and 218 has a width or diameter gradually decreasing downward from the top surface of the light guide plate 200. Thus, the light guide plate 200 may be easily manufactured. That is, a mold for forming the total reflection grooves 212, 213, 214, 215, 216, 217, and 218 may be easily detached.

As shown in FIG. 12, the optical path conversion parts 211 may change a path of light emitted from the LEDs 100. In more detail, the optical path conversion parts 211 may change the path of the light so that an angle between a traveling direction of the light emitted from the LEDs 100 and the optical axis P1 of each of the LEDs 100 is increased. That is, the optical path conversion parts 211 may change the path of the light emitted from the LEDs 100 so that the path is away from the optical axis P1 of each of LEDs 100.

The LEDs 100 may be disposed on a side surface of the light guide plate 200. In more detail, the LEDs 100 may be disposed on the light incident surface.

The LEDs 100 may be light sources for generating light. In more detail, the LEDs 100 may emit light toward the wavelength conversion part 300.

Although four LEDs 100 are provided in the drawings, the present disclosure is not limited thereto. For example, nine LEDs 100 may be provided.

Each of the LEDs 100 may be a blue LED generating blue light or an UV LED generating UV rays. That is, the LED 100 may generate the light having a wavelength band of about 430 nm to about 470 nm or an ultraviolet ray having wavelength band of about 300 nm to about 40 nm.

The LEDs 100 are mounted on the FPCB 400. The LEDs 100 are disposed under the FPCB 400. The LEDs 100 receive a driving signal through the FPCB 400 and then are driven.

The wavelength conversion part 300 is disposed between the LEDs 100 and the light guide plate 200. The wavelength conversion part 300 adheres to the side surface of the light guide plate 200. In detail, the wavelength conversion part 300 is attached to the light incident surface of the light guide plate 200. Also, the wavelength conversion part 300 may adhere to the LEDs 100.

The wavelength conversion part 300 receives light emitted from the LEDs 100 to convert a wavelength of the light. For example, the wavelength conversion part 300 may convert blue light emitted from the LEDs 100 into green light and red light. That is, the wavelength conversion part 300 may convert a portion of the blue light into the green light having a wavelength band of about 520 nm to about 560 nm and the other portion of the blue light into the red light having a wavelength band of about 630 nm to about 660 nm. Also, the wavelength conversion part 300 may convert ultraviolet rays emitted from the

LEDs 100 into blue, green, and red light. That is, the wavelength conversion part 300 may convert a portion of the ultraviolet rays into blue light having a wavelength band of about 430 nm to about 470 nm, another portion of the ultraviolet rays into green light having a wavelength band of about 500 nm to about 600 nm, and further another portion of the ultraviolet rays into red light having a wavelength band of about 630 nm to about 660 nm.

Thus, the light transmitting the wavelength conversion part 300 and the light converted by the wavelength conversion part 300 may generate white light. That is, the blue light, the green light, and the red light may he combined with each other to generate the white light, and then, the generated white light may be incident into the light guide plate 200.

Referring to FIG. 3, the wavelength conversion part 300 includes a tube 310, a sealing member (not shown), a plurality of wavelength conversion particles 320, and a host 330.

The tube 310 receives the sealing member, the wavelength conversion particles 320, and the host 330. That is, the tube 310 may be a container for receiving the sealing member, the wavelength conversion particles 320, and the host 330. Also, the tube 310 has a shape longitudinally extending in one direction.

The tube 310 may have a square tube shape. That is, the tube 310 may have a rectangular shape in a section of a direction perpendicular to a length direction thereof. Also, the tube 310 may have a width of about 0.6 mm and a height of about 0.2 mm. That is, the tube 310 may be a capillary tube.

The sealing member is disposed inside the tube 310. The sealing member is disposed on an end of the tube 310. The sealing member seals the inside of the tube 310. The sealing member may be formed of an epoxy resin.

The wavelength conversion particles 320 arc disposed inside the tube 310. In detail, the wavelength conversion particles 320 are uniformly dispersed in the host 330, and the host 330 is disposed inside the tube 310.

The wavelength conversion particles 320 convert a wavelength of light emitted from the LEDs 100. The wavelength conversion particles 320 receive the light emitted from the LEDs 100 to convert the wavelength of the light. For example, the wavelength conversion particles 320 may convert the blue light emitted from the LEDs 100 into green light and red light. That is, a portion of the wavelength conversion particles 320 may convert the blue light into the green light having a wavelength band of about 520 nm to about 560 nm, and the other portion of the wavelength conversion particles 320 may convert the blue light into the red light having a wavelength band of about 630 nm to about 660 nm.

On the other hand, the wavelength conversion particles 320 may convert an ultraviolet ray emitted from the LEDs 100 into blue, green, and red light. That is, a portion of the wavelength conversion particles 320 may convert the ultraviolet rays into blue light having a wavelength band of about 430 nm to about 470 nm, and another portion of the wavelength conversion particles 320 may convert the ultraviolet rays into green light having a wavelength band of about 520 nm to about 560 nm, Also, further another portion of the wavelength conversion particles 320 may convert the ultraviolet rays into red light having a wavelength band of about 630 nm to about 660 nm.

That is, when the LEDs 100 are the blue LEDs emitting the blue light, the wavelength conversion particles 320 for respectively converting the blue light into the green and red light may be used. On the other hand, when the LEDs 100 are the UV LEDs emitting the ultraviolet rays, the wavelength conversion particles 320 for respectively converting the ultraviolet rays into the blue, green, and red light may be used.

The wavelength conversion particles 320 may be a plurality of quantum dots QDs. Each of the quantum dots QDs may include a core nano crystal and a shell nano crystal surrounding the core nano crystal. Also, the quantum dot QD may include an organic ligand coupled to the shell nano crystal. Also, the quantum dot QD may include an organic coated layer surrounding to the shell nano crystal.

The shell nano crystal may have two-layered structure. The shell nano crystal is disposed on a surface of the core nano crystal. The quantum dot QD may convert a wavelength of light incident into the core nano crystal into light having a long wavelength through the shell nano crystal forming a shell layer to improve light efficiency.

The quantum dot QD may be formed of at least one material of a group 11 compound semiconductor, a group III compound semiconductor, a group V compound semiconductor, and a group VI compound semiconductor. In detail, the core nano crystal may be formed of Cdse, InGaP, CdTe, CdS, ZnSe, ZnTe, ZnS, HgTe, or HgS. Also, the shell nano crystal may be formed of CuZnS, CdSe, CdTe, CdS, ZnSe, ZnTe, ZnS, HgTe, or HgS. The quantum dot QD may have a diameter of about 1 nm to about 10 nm.

The wavelength of the light emitted from the quantum dot QD may be adjusted according to a size of the quantum dot QD or a molar ratio of a molecular cluster compound and a nano particle precursor in a synthesis process. The organic ligand may be formed of at least one of pyridine, mercapto alcohol, thiol, phosphine, and phosphine oxide. The organic ligand may stabilize the unstable quantum dot QD after the synthesis process is performed. After the synthesis process is performed, a dangling bond is formed outside the quantum dot QD. Thus, the quantum dot QD may be instable due to the dangling bond. However, one end of the organic ligand may be in a non-bonded state, and the non-bonded one end of the organic ligand may be bonded to the dangling bond to stabilize the quantum dot QD.

Specifically, when the quantum dot QD has a radius less than a Bohr radius of an exciton constituted by an electron and hole, which are excited by light and electricity, a quantum confinement effect may occur. Thus, the quantum dot QD has a discrete energy level to change an intensity of an energy gap. In addition, a charge may be limited within the quantum dot QD to provide high light emitting efficiency.

The quantum dot QD may be changed in emission wavelength according to a particle size thereof, unlike a general fluorescent dye. That is, when the particle size is gradually decreased, the quantum dot QD may emit light having a short wavelength. Thus, the particle size may be adjusted to emit visible light having a desired wavelength. Also, since the quantum dot QD has an extinction coefficient greater by about 100 times to about 1,000 times than that of the general fluorescent dye and quantum yield greater than that of the general fluorescent dye, the quantum dot QD may emit very intense light.

The quantum dot QD may be synthesized by a chemical wet etching process. Here, the chemical wet etching process is a process in which a precursor material is immersed into an organic solvent to grow particles. Thus, the quantum dot QD may be synthesized through the chemical wet etching process.

The host 330 surrounds the wavelength conversion particles 320. That is, the wavelength conversion particles 320 are uniformly dispersed into the host 330. The host 330 may be formed of a polymer. The host 330 is transparent. That is, the host 330 may be formed of a transparent polymer.

The host 330 is disposed inside the tube 310. That is, the host 330 is filled into the tube 310 as a whole. The host 330 may be closely attached to an inner surface of the tube 310.

An air layer may be disposed between the sealing member and the host 330. The air layer is filled with nitrogen. The air layer may serve as a buffer layer between the sealing member and the host 330.

The wavelength conversion part 300 may be formed by following processes.

First, the wavelength conversion particles 320 are uniformly dispersed in a resin composition. The resin composition is transparent. The resin composition may have a photocurable propriety.

Thereafter, an internal pressure of the tube 310 may be decreased, and an inlet of the tube 310 is immersed by the resin composition in which the wavelength conversion particles 320 are dispersed. Thus, a pressure around the tube 310 may be increased. Accordingly, the resin composition in which the wavelength conversion particles 320 arc dispersed is introduced into the tube 310.

Thereafter, a portion of the resin composition introduced into the tube 310 is removed to empty the inlet of the tube 310.

Thereafter, the resin composition introduced into the tube 310 is cured by the ultraviolet rays to form the host 330.

Then, an epoxy-based resin composition is introduced into the inlet of the tube 310. Thereafter, the introduced epoxy-based resin composition is cured to form the sealing member. The process for forming the sealing member is performed under nitrogen atmosphere. Thus, an air layer containing nitrogen may be formed between the sealing member and the host 330.

An adhesion member 301 is disposed between the light guide plate 200 and the wavelength conversion part 300. The wavelength conversion part 300 adheres to the light incident surface 201 of the light guide plate 200 by the adhesion member 301. Here, the adhesion member 301 is closely attached to the wavelength conversion part 300 and the light incident surface 201 of the light guide plate 200.

Also, the adhesion member 301 is disposed between the LEDs 100 and the wavelength conversion part 300. The LEDs 100 adhere to the wavelength conversion part 300 by the adhesion member 301. Here, the adhesion member 301 is closely attached to the wavelength conversion part 300 and the light emission surface of the LEDs.

An air layer does not exist between the LEDs 100 and the light guide plate 200 due to the adhesion member 301. Thus, media between the LEDs 100 and the light guide plate 200 are little different in refractive index.

The optical sheets 500 are disposed on the light guide plate 200. The optical sheets 500 improve optical characteristics of light which transmits them.

The FPCB 400 is electrically connected to the LEDs 300. The FPCB 400 may mount the LEDs 300. The FPCB 400 may be a flexible printed circuit board 400 and disposed inside the mold frame 10. The FPCB 400 is disposed on the light guide plate 200.

The mold frame 10 and the backlight assembly 20 constitute the backlight unit. That is, the backlight unit includes the mold frame 10 and the backlight assembly 20.

The liquid crystal panel 30 is disposed inside the mold frame 10 and on the optical sheets 500.

The liquid crystal panel 30 adjusts intensity of the transmitting light to display an image. That is, the liquid crystal panel 30 is a display panel for displaying an image. The liquid crystal panel 30 includes a TFT substrate, a color filter substrate, a liquid crystal layer between the TFT substrate and the color filter substrate, and a polarizing filter.

As described above, referring to FIG. 12, light L1 emitted at a predetermined angle with respect to an optical axis P1 is not totally reflected by the optical path conversion part 211. On the other hand, light L2 emitted from the neighborhood of the optical axis P1 is totally reflected in left and right directions by the optical path conversion part 211. Thus, it is seen that an amount of light is uniform as the whole.

Also, since the optical path conversion part 211 is adjusted to disperse light into a region between the light sources 100 as a distance between the light sources 100 is increased, light uniformity may be maintained event though the distance between the light sources 100 is widened.

Also, the other portion of light emitted from the LEDs is converted into light having a different wavelength by the wavelength conversion part 300. As described above, when a wavelength is changed by the wavelength conversion particles 320, the converted light may be randomly emitted from the wavelength conversion particles 320. That is, the wavelength conversion particles 320 may emit light converted in various directions regardless of incident light.

Specifically, the light sources 100 may be blue LEDs. Also, the wavelength conversion part 300 may convert blue light emitted from the blue LEDs into red light and green light. Thus, the red light and the green light may have a divergence angle greater than that of the blue light.

Here, the liquid crystal display device according to an embodiment may change a path of light emitted from the blue LEDs to prevent a yellowish phenomenon from occurring. The yellowish phenomenon is a phenomenon in which the blue light is lacked as the light is away from the optical axes of the blue LEDs.

Thus, the liquid crystal display device according to an embodiment may have improved brightness and color uniformity.

Specifically, referring to FIG. 13, a uniform chromaticity coordinate value is measured in blue color CY and red color CX. Thus, it is confirm that color non-uniformity due to positions of the LEDs is solved. Also, referring to FIG. 14, it is confirm that the brightness uniformity according to the positions of the LEDs is improved as the whole.

The optical path conversion part according to the embodiment is disposed corresponding to the light source. The optical path conversion part may changes a path of light emitted from the light source in lateral direction.

Therefore, the display device according to the embodiment may prevent the brightness around the light source from being increased when compared to that of the other portion, thereby improving brightness uniformity. Also, since the brightness uniformity is improved, desired brightness may be realized even though a small number of light sources is provided.

The liquid crystal display device according to the embodiment may be used in display fields.

Features, structures, and effects described in the above embodiments are incorporated into at least one embodiment of the present disclosure, but are not limited to only one embodiment. Moreover, features, structures, and effects exemplified in one embodiment can easily be combined and modified for another embodiment by those skilled in the art. Therefore, these combinations and modifications should be construed as falling within the scope of the present disclosure.

Although embodiments have been described with reference to illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims.

What is claimed is:

1. A display device comprising:
a light guide plate; and
a light source disposed on a lateral surface of the light guide plate,
wherein an optical path conversion part corresponding to the light source is disposed in the light guide plate.

2. The display device according to claim 1, further comprising a display panel disposed on the light guide plate,
wherein the display panel has an active display region in which an image is displayed,
the light guide plate has a central region corresponding to the active display region and a peripheral region between the central region and the light source, and
the optical path conversion part is disposed in the peripheral region.

3. The display device according to claim 1, further comprising a wavelength conversion part,
wherein the wavelength conversion part is closely attached to the light source and the light guide plate.

4. The display device according to claim 1, wherein the optical path conversion part comprises:
a first reflection surface inclined with respect to an optical axis of the light source; and
a second reflection surface inclined with respect to the optical axis of the light source.

5. The display device according to claim 4, wherein a portion at which the first reflection surface and the second reflection surface meet each other corresponds to the optical axis of the light source.

6. The display device according to claim 4, wherein the first reflection surface perpendicularly crosses a top surface of the light guide plate.

7. The display device according to claim 4, wherein the first reflection surface is inclined with respect to a top surface of the light guide plate.

8. The display device according to claim 1, wherein the optical path conversion part has a groove defined in the light guide plate.

9. The display device according to claim 8, wherein the groove has a cylindrical shape.

10. The display device according to claim 8, wherein the groove passes through the light guide plate.

11. A display device comprising:
a light guide plate; and
a light source disposed on a lateral surface of the light guide plate,
wherein a groove corresponding to the light source is defined in the light guide plate.

12. The display device according to claim 11, wherein the groove is defined in a top surface of the light guide plate.

13. The display device according to claim 11, wherein the groove passes through the light guide plate.

14. The display device according to claim 11, wherein the groove comprises:
a first inner surface inclined with respect to an optical axis of the light source; and
a second inner surface inclined with respect to the optical axis of the light source,
wherein a portion at which the first inner surface and the second inner surface meet each other corresponds to the optical axis of the light source.

15. The display device according to claim 11, wherein the groove has a truncated pyramid shape, a triangular pyramid shape, a truncated circular cone shape, a cone shape, a cylindrical shape, a quadrangular pyramid frustum shape, or a quadrangular pyramid shape.

16. The display device according to claim 11, wherein the groove has an eccentric cone shape.

17. A display device comprising:
a display panel;
a light guide plate disposed under the display panel; and
a plurality of light sources emitting light onto the light guide plate,
wherein grooves respectively corresponding to the light sources are defined in the light guide plate.

18. The display device according to claim 17, wherein the display panel is an active display region in which an image is displayed,
the light guide plate has a central region corresponding to the active display region and a peripheral region between the central region and the light source, and
the grooves are defined in the peripheral region.

19. The display device according to claim 17, wherein the grooves are defined in a top surface of the light guide plate, and
a ratio of a thickness of the light guide plate to a depth of each of the grooves is about 1:0.6 to about 1:0.99.

20. The display device according to claim 17, wherein the grooves pass through the light guide plate.
